(19) United States
(12) Patent Application Publication
(10) Pub. No.: US 2024/0043022 A1
(43) Pub. Date: Feb. 8, 2024

(54) METHOD, SYSTEM, AND COMPUTER PROGRAM PRODUCT FOR OBJECTIVE ASSESSMENT OF THE PERFORMANCE OF AN ADAS/ADS SYSTEM

(71) Applicant: Dr. Ing. h.c. F. Porsche Aktiengesellschaft, Stuttgart (DE)

(72) Inventor: Moritz Markofsky, Renningen (DE)

(21) Appl. No.: 18/215,385

(22) Filed: Jun. 28, 2023

(30) Foreign Application Priority Data
Aug. 5, 2022 (DE) 10 2022 119 715.8

(51) Int. Cl. B60W 50/04; B60W 60/00; G06N 3/04

(52) U.S. Cl. CPC B60W 50/045; B60W 60/001; G06N 3/04

(57) ABSTRACT

A method for objective assessment of performance of an ADAS/ADS system (210) of a vehicle (200) for a defined driving task in at least one selected scenario (SZᵢ). The method includes identifying real-world scenarios (SZrᵢ) from data captured in real-time by sensors (220) while traveling on a test path with the vehicle (200) or from stored data; generating simulated scenarios (SZsᵢ) from a simulation module (400). The method continues by calculating an assessment indicator (570) for at least one real-world scenario (SZrᵢ) and/or an assessment indicator (570) for at least one simulated scenario (SZscᵢ) from an assessment module (500). The assessment indicator (570) represents the performance of the ADAS/ADS system (210) for the defined driving task. The method then includes generating (S50) evaluation results (750) from an evaluation module (700).

### CROSS REFERENCE TO RELATED APPLICATION

This application claims priority on German Patent Application No 10 2022 119 715.8 filed Aug. 5, 2022, the entire disclosure of which is incorporated herein by reference.

### BACKGROUND

### Field of the Invention

The invention relates to a method, system, and computer program product for objective assessment of the performance of an ADAS/ADS system.

### Related Art

Modern vehicles are equipped with a variety of driver assistance systems or automated driving assistance functions to assist the driver in driving and to increase safety. For example, driver assistance systems support speed and distance control and contain lane-keeping and lane-changing functions. A certain maximum speed can be set that is not exceeded as long as the speed limiting function is enabled. Distance controls use radar sensor and/or camera systems to monitor and maintain a certain distance from a vehicle ahead and vehicles in the side region. This leads to improved driving convenience and safety, especially when driving on a highway and during overtaking maneuvers.

This trend towards advanced driver assistance systems (ADAS) and automated driving systems (ADS) for motor vehicles, aircraft, marine vehicles and other moving objects requires extensive safeguarding strategies, because the responsibility for vehicle management is no longer entirely with the driver, but rather active functions are taken over by computer units in the vehicle. These systems employed in fully or semi-autonomously moving objects must have a very low error rate in their driving behavior. The detection and classification of other objects and the interpretation of traffic scenarios near a vehicle are important prerequisites to ensure a safe functionality of an ADAS/ADS system. For this purpose, the targeted testing and training of the advanced driver assistance systems and automated driving systems are required for both extreme and exceptional situations (corner cases) and also for day-to-day situations. Such extreme situations result from a particular combination of factors. Examples of these factors are infrastructural particularities, such as the type of road, the edge construction on a road and the quality of the markings as well as ambient conditions, such as weather, the time of day and the time of year. Furthermore, the behavior of the other road users, the geographic topography and the weather conditions play a major role.

Key performance indicators (KPI) are used to evaluate the performance and functionality of one or more functions or the overall performance of an ADAS/ADS system. KPIs are primarily numeric values, for example on a scale of 1 to 100. KPIs are used to describe the performance of an ADAS/ADS system, and KPIs can be established for various evaluation categories such as comfort, safety, naturalness of travel and efficiency. Additionally, further KPIs can be implemented to verify the correct functionality of an ADAS/ADS system. One example of a KPI is the evaluation of a minimum distance from another vehicle or a mean acceleration in a deceleration scenario.

ADAS/ADS systems typically are developed independently by various manufacturers and thus differ from one another, for example in terms of the components used, the software versions, and the application datasets. The calculated KPIs are therefore context-dependent, because they are dependent on both the performance of a specific ADAS/ADS system and the scenario under consideration. Therefore, KPIs for variously configured ADAS/ADS systems can only be compared to one another in part, because it is not always clear whether the ADAS/ADS systems have also been tested with the same scenarios and from which data sources the scenarios have been generated. The meaningful value of a KPI metric therefore often only relates to a specific ADAS/ADS system, so that the comparability of KPIs is difficult for variously formed ADAS/ADS systems and results in inaccurate outcomes. This results in the performance of an ADAS/ADS system often not being objectively evaluated because a consistent metric for assessment is lacking.

DE 10 2019 209554 A1 discloses a method for testing the robustness of a technical system that can be simulated, wherein the technical system is simulated as a function of a test scenario and a test configuration, and the simulation result is evaluated.

DE 10 2017 221971 A1 discloses a method for adjusting a vehicle control system to an altered vehicle state, wherein a control quality of the vehicle control system is assessed, taking into account at least one control criterion. The control criterion is determined for a specific driving scenario by means of a simulation.

DE 10 2020 120141 A1 discloses a method for optimizing tests of control systems for automated driving dynamic systems, wherein relevant parameters and relevant system responses are defined and quasi-random parameter combinations of the relevant parameters and system responses of the test system are generated. A probabilistic system model is created and trained as a function of the generated parameter combinations and the system responses. System responses of the model generated by the system model then are assessed.

DE 10 2018 215351 A1 discloses a method for generating an information collection of driving scenarios. Data of the driving scenarios is generated by sensor data from at least one vehicle.

An object of the invention is to specify possibilities for analyzing and comparing assessment indicators (KPIs) for various test drives and variously trained advanced driver assistance systems (ADAS) and/or automated driving systems (ADS), which differ from one another with regard to the software versions used and application datasets to create the conditions for objective comparability of the performance of variously configured ADAS/ADS systems and/or driving functions.

### SUMMARY OF THE INVENTION

In accordance with one aspect of the invention, test results from variously configured ADAS/ADS systems can be evaluated objectively and compared to one another by generating assessment indicators for scenarios. The scenarios can be real-world scenarios that were measured in real-world time or created from historical data, as well as simulated scenarios generated by simulation software. According to the invention, a calculated assessment indicator is set for a considered scenario in relation to a scenario parameter value of a selected scenario parameter of the scenario. This results in an objective metric for a calculated assessment indicator so that, based on the objective metric, the assessment indicators from various ADAS/ADS systems can be compared to one another. In a further development, the simulated scenarios generated by simulation and the scenarios created from measurements are compared to one another, and the quality of a simulation method can be derived from this comparison. The invention thus allows the performance of an ADAS/ADS system to be assessed objectively, precisely, and comprehensibly so that a comparison of variously configured ADAS/ADS systems is made possible, and possible measures for improvement can be developed. Overall, the estimation of the safety and functionality of one or more driving functions of an ADAS/ADS system for a particular driving task can thus be adjusted and improved significantly.

A first aspect of the invention provides a method for objective assessment of the performance of an ADAS/ADS system of a vehicle for a defined driving task in at least one selected scenario, in particular for testing and training at least one driving function of the advanced driver assistance system (ADAS) and/or the automated driving system (ADS). A scenario represents a traffic event in a time sequence and is defined by a selection of scenario parameters and associated scenario parameter values. The method comprises the method steps:
identifying specific real-world scenarios from data captured in real-time by sensors while traveling on a test path with the vehicle or from stored data from a scenario identification module;
generating simulated scenarios from a simulation module;
communicating the real-world scenarios and/or the simulated scenarios to an assessment module;
calculating an assessment indicator for at least one real-world scenario and/or an assessment indicator for at least one simulated scenario from the assessment module, where the assessment indicator represents the performance of the ADAS/ADS system for the defined driving task;
generating evaluation results from an evaluation module, where an evaluation result for a real-world scenario and/or a simulated scenario includes a mapping between the respectively determined assessment indicator and the scenario parameter value of a selected scenario parameter of the respective real-world scenario and/or the respective simulated scenario.

In a further development, the scenario parameter value of the selected scenario parameter of the respective real-world scenario and/or the respective simulated scenario is extracted by the evaluation module from the dataset of the real-world scenario and/or the simulated scenario.

In one embodiment, the assessment indicators comprise key performance indicators (KPIs).

In a further embodiment, the evaluation results are configured as KPI plots, and the values of a KPI in a KPI plot are represented as a function of the parameter values of a scenario parameter for a particular scenario, and each plot point includes a real-world scenario or a simulated scenario.

In particular, the KPI plots for variously formed ADAS/ADS systems and/or the KPI plots for various real-world scenarios and/or for simulated scenarios and real-world scenarios for an ADAS/ADS system are compared to one another. The KPI plots may be configured as histograms with segments for cluster analysis.

In a another development, the scenario identification module comprises a software application that uses the computational methods and/or algorithms of artificial intelligence; the simulation module comprises a software application that uses the computational methods and/or algorithms of artificial intelligence; the assessment module comprises a software application that uses the computational methods and/or algorithms of artificial intelligence; and the evaluation module comprises a software application that uses the computational methods and/or algorithms of artificial intelligence.

The computational methods and/or algorithms of artificial intelligence may be configured as mean values, minimum and maximum values, lookup tables, expected value models, linear regression methods, Gaussian processes, fast Fourier transforms, integral and differential calculations, Markov methods, probability methods, such as Monte Carlo methods, temporal difference learning, extended Kalman filters, radial basis functions, data fields, convergent neural networks, deep neural networks, recurrent neural networks, and/or folded neural networks.

A scenario parameter may comprise: a physical variable, a chemical variable, a torque, a speed, a voltage, a current strength, a speed, an acceleration, a lurch, a braking value, a direction, an angle, a radius, a location, a number, a movable object such as a motor vehicle, a person or a cyclist, a stationary object such as a building or tree, a road configuration such as a highway, a road sign, a traffic light, a tunnel, a roundabout, a turn-off lane, a traffic volume, a topographical structure such as an incline, a time, a temperature, a precipitation value, a weather condition and/or a time of year.

According to a second aspect, the invention provides a system for objective assessment of the performance of an ADAS/ADS system of a vehicle for a defined driving task in at least one selected scenario, in particular for testing and training at least one driving function of the advanced driver assistance system (ADAS) and/or the automated driving system (ADS). A scenario represents a traffic event in a time sequence and is defined by a selection of scenario parameters and associated scenario parameter values. The system comprises sensors connected to the vehicle, a scenario identification module, a simulation module, an assessment module, and an evaluation module. The sensors are configured to record data in real-time while traveling with the vehicle on a test path. The scenario identification module is configured to identify real-world scenarios from the real-time captured data of the sensors or from stored data. The simulation module is configured to generate simulated scenarios. The assessment module is configured to calculate an assessment indicator for at least one real-world scenario and/or an assessment indicator for at least one simulated scenario. The assessment indicator represents the performance of the ADAS/ADS system for the defined driving task. The evaluation module is configured to generate evaluation results. An evaluation result for a real-world scenario and/or a simulated scenario includes mapping between the determined assessment indicator and the scenario parameter value of a selected scenario parameter of the respective real-world scenario and/or the respective simulated scenario.

In a further development that the assessment indicators are configured as key performance indicators (KPIs) and the evaluation results are configured as KPI plots.

In a KPI plot, the values of a KPI are represented as a function of the parameter values of a scenario parameter for a particular scenario, and each plot point includes a real-world scenario or a simulated scenario.

In particular, the KPI plots for variously formed ADAS/ADS systems and/or the KPI plots for various real-world scenarios and/or for simulated scenarios and real-world scenarios for an ADAS/ADS system are compared to one another.

According to a third aspect, the invention provides an ADAS/ADS system for a vehicle that uses the method according to the first aspect for testing and training and/or for calibration and validation of the ADAS/ADS system.

According to a fourth aspect, the invention relates to a computer program product comprising an executable program code configured to carry out the method according to the first aspect when it is executed.

The invention is explained in further detail below on the basis of an exemplary embodiment shown in the drawings.

### BRIEF DESCRIPTION OF THE DRAWINGS

FIG. 1 is a block plot to explain an exemplary embodiment of a system according to the invention.

FIG. 2 is a schematic representation of a KPI plot.

FIG. 3 is a schematic representation of a KPI plot for a cut-in scenario.

FIG. 4 is a flowchart to explain the individual method steps of a method according to the invention.

FIG. 5 is a block plot of a computer program product according to an embodiment of the third aspect of the invention.

### DETAILED DESCRIPTION

Real-world and also increasingly simulated traffic scenarios created by programming are used for testing, training, and securing driver assistance systems (ADAS) and automated driving systems (ADS). A scenario in the context of the invention is defined as a traffic event in a temporal sequence. An example of a scenario is driving on a highway bridge, turning off on a turn-off lane, passing through a tunnel, turning onto a roundabout, or stopping in front of a pedestrian crossing. Moreover, specific visibility conditions, for example due to twilight or bright sunlight, as well as environmental conditions such as the weather and the time of year, traffic levels, and certain geographic topographical conditions, can affect a scenario. For example, an overtaking maneuver can be described as a scenario in which a first vehicle is initially behind another vehicle, then makes a lane change to the other roadway, and increases speed to overtake the other vehicle. Such a scenario is also referred to as a cut-in scenario.

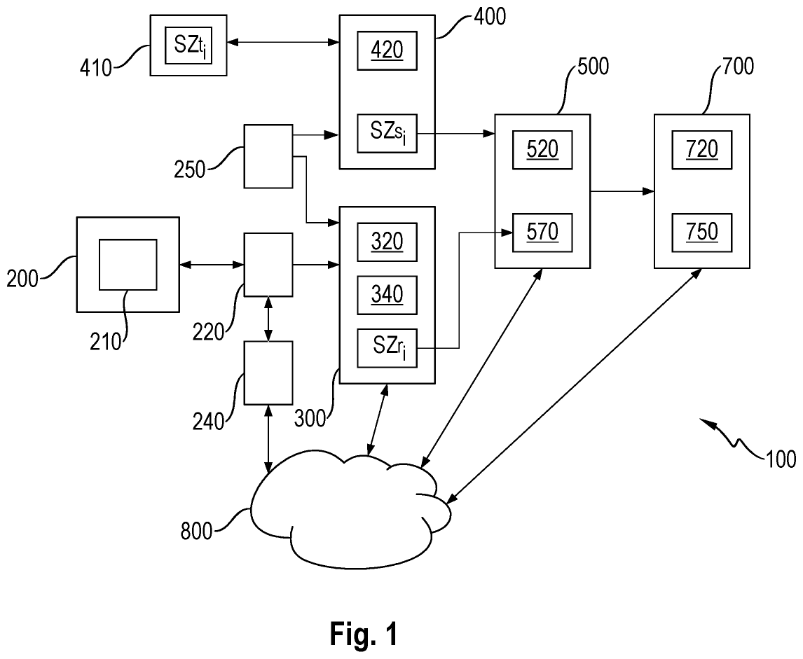

FIG. 1 shows a system 100 according to an embodiment of the invention for objective assessment of the performance of an advanced driver assistance system (ADAS) and/or an automated driving system (ADS). The system 100 comprises a vehicle 200 having an ADAS/ADS system 210 with one or more travel functions. The vehicle 200 is connected to sensors 220 that capture data in the form of measurement data and images from the environment of the vehicle 200 and the behavior of the ADAS/ADS system 210 along a test path. The data of the sensors 220 can be forwarded directly to a scenario identification module 300 or stored in a database 240. The database 240 also is associated with the scenario identification module 300 for transmitting stored data. Furthermore, a simulation module 400 is provided and can be associated, for example, with a test scenario database 410 for creating simulated scenarios. An input module 250 is associated with the scenario identification module 300 and the simulation module 400. The input module 250 comprises a user interface that may comprise a touch screen, a microphone, a camera, etc. The real-world scenarios identified by the scenario identification module 300 SZrᵢ and the scenarios simulated by simulation module 400 SZsᵢ are forwarded to an assessment module 500. The assessment results produced by the assessment module 500 are evaluated by an evaluation module 700. The input module 250, the scenario identification module 300, the simulation module 400, the assessment module 500, and the evaluation module 700 can each be provided with a processor and/or a memory unit.

A “module” can be understood, for example, in connection with this disclosure to mean a processor and/or a processor unit and/or a memory unit for storing program instructions. The processor is configured to execute the program instructions for implementing or realizing the method disclosed herein or a step of the method. In particular, a module can be integrated into a cloud computing infrastructure 800.

A “processor” is understood in connection with the invention to mean, for example, a machine or an electronic circuit. In particular, a processor can be a master processor (central processing unit (CPU)), a microprocessor, or a microcontroller, for example an application-specific integrated circuit or a digital signal processor, optionally in combination with a memory unit for storing program instructions, etc. A processor also can mean a virtualized processor, a virtual machine, or a soft CPU. For example, it can also be a programmable processor equipped with configuration steps for carrying out the method or configured with configuration steps in such a way that the programmable processor realizes the features of the method, the system, the modules, or other aspects and/or partial aspects of the invention. In particular, the processor can include highly parallelized computing units and high-performance graphics modules.

In connection with the invention, a “storage module” may be a volatile memory in the form of a working memory (random access memory, RAM), or a permanent memory such as a hard drive or a data carrier or, for example, a replaceable memory module. However, the storage module can also be a cloud-based storage solution.

“Data base” means both a memory algorithm and hardware in the form of a memory unit. In particular, a database can be part of a cloud computing infrastructure.

“Data” in connection with the invention should be understood as raw data as well as data already prepared from measurement results from sensors as well as from other data sources.

The objective assessment of the performance of an ADS/ADS system 210 and/or a travel function is based according to this disclosure on real-world scenarios SZrᵢ that occur during testing of the ADAS/ADS system 210 along a travel path and/or simulated scenarios SZsᵢ. Both a real-world scenario SZrᵢ and a simulated scenario SZsᵢ are defined by various scenario parameters P₁, P₂, . . . , Pₙ from a large number of possible scenario parameters Pᵢ and associated scenario parameter values P₁, P₂, . . . , Pₙ from a large number of possible scenario parameter values PVᵢ, wherein scenario parameter values PVᵢ define the range of values of a scenario parameter Pᵢ. For example, a scenario parameter Pᵢ sets a physical variable, a chemical variable, a torque, a rotary speed, a voltage, a current strength, an acceleration, a speed a braking value, a direction, an angle, a radius, a location, a number, a movable object such as a motor vehicle, a person or a cyclist, a stationary object such as a building or a tree, a road configuration such as a highway, a road sign, a traffic light, a tunnel, a roundabout, a turn-off lane, a traffic volume, a topographical structure such as an incline, a time, a temperature, a precipitation value, a weather condition and/or a time of year. Scenario parameters Pᵢ thus denote characteristics and features of a scenario SZᵢ in the context of the present invention. An example of a scenario parameter Pᵢ of a scenario SZᵢ is the speed of an ego vehicle. For this scenario parameter “speed,” the range of values of the associated scenario parameter value PVᵢ can comprise the range of 100 km/h to 180 km/h. By contrast, for another scenario SZₖ, the range of values of the parameter value PVᵢ can range from 40 km/h to 70 km/h for the scenario parameter “speed.”

The real-world scenarios SZrᵢ based on real-world testing and measurements that arise when the vehicle 200 equipped with the ADAS/ADS system 210 is traveling along a test path are identified by the scenario identification module 300 using the software application 320 by means of the data captured by the sensors 220 in real-time and/or by means of stored data in the database 240 and optionally extended with additional requirement specifications that can be input using the input module 250.

The sensors 220 can be configured as radar systems with one or more radar sensors, LIDAR systems for optical distance and speed measurement, 2D/3D image recording cameras in the visible, IR and/or UV range, and/or GPS systems. Furthermore, accelerometers, speed sensors, capacitive sensors, inductive sensors, voltage sensors, torque sensors, engine speed sensors, precipitation sensors, and/or temperature sensors, etc. can be provided.

Data can be stored in the database 240 in the form of images, graphics, time series, characteristic values, etc. For example, target variables and target values that define a safety standard can be stored in the database 240. Furthermore, road network data can be provided with road specifications such as lanes and bridges, road infrastructure such as road surface, edge construction, roadway guidance, country-specific characteristics, weather conditions, etc. The database 240 can also be integrated into a cloud computing infrastructure 800.

A suitable real-world scenario SZrᵢ is derived from the data captured by the sensors 220 in real-time at a particular geographic location and/or from the data stored in the database 240 by the software application 320 of the scenario identification module 300. In particular, the software application 320 uses artificial intelligence algorithms to identify the real-world scenarios SZrᵢ. The artificial intelligence algorithms can be encoders and decoders with neural networks.

A neural network has neurons arranged in multiple layers and interconnected to one another variously. A neuron is able to receive information at its input from outside or from another neuron, evaluate the information in a particular manner, and pass it on in altered form at the neuron output to another neuron, or output it as a final result. Hidden neurons are located between the input neurons and the output neurons. Depending on the type of network, multiple layers of hidden neurons can be present and provide the forwarding and processing of the information. Output neurons deliver a result and issue it to the outside world. Neural networks can be trained through unsupervised or supervised learning.

The arrangement and linking of the neurons result in various types of neural networks, such as a feedforward neural network (FNN), a recurrent neural network (RNN) or a convolutional neural network (CNN). A convolutional neural network has multiple fold layers and is well suited to machine learning, pattern recognition and image recognition applications. Because a large proportion of the data captured by the sensors is present as images, particularly convolutional neural networks (CNN) are used.

The identified real-world scenarios SZrᵢ can be stored in a scenario database 340. The data for an identified real-world scenario SZrᵢ can include the designation for the selected real-world scenario SZrᵢ. In particular, the important scenario parameters Pᵢ of the scenario SZrᵢ are saved.

The simulation module 400 also uses a software application 420 to generate simulated scenarios SZsᵢ. The software application 420 can also use algorithms of artificial intelligence for this purpose. In particular, the simulation module 400 can be associated with a test scenario database 410 in which test scenarios SZtᵢ, scenario parameters Pᵢ, scenario parameter values PVᵢ, and other information generated from various data sources are stored. The test scenario database 410 can also be integrated into a cloud computing infrastructure 800. In addition, the simulation module 400 can be associated with further databases, in particular the database 240, in which additional information for performing a simulation is stored.

The software application 420 of the simulation module 400 can create test cases SZtᵢ for one or more driving tasks of the ADAS/ADS system 210 to be tested by selecting appropriate test scenarios Pᵢ and scenario parameters PVᵢ as well as scenario parameter values Tᵢ and optionally further information. The particular driving task is formulated prior to starting the simulation, for example, by an expert such as an engineer. However, it can also be provided that the driving task is specified by a software application. An example of a driving task is to perform a passing maneuver on a highway, also referred to as a cut-in maneuver.

Such a cut-in scenario can be described by the speed v_{ego} of the first-person vehicle 200, the speed v_{target} of a target vehicle, the spatial distance d_{cutin} between the two vehicles, and the spatial length l_{cutin} of the passing maneuver. The speed of one or both vehicles can also change during the passing maneuver through an acceleration or braking operation. This also applies to the spatial distance d_{cutin} between the two vehicles.

The following table shows possible scenario parameters Pᵢ and scenario parameter values PVᵢ of a cut-in scenario:

| Scenario parameters Pᵢ | Scenario parameter value PVᵢ | |
|---|---|---|
| v_{ego} | 10-250 | km/h |
| v_{target} | 10-250 | km/h |
| d_{cutin} | 10-100 | m |
| l_{cutin} | 10-100 | m |

In particular, a test strategy can be provided for the selection and design of the test cases Tᵢ in the simulation, which specifies how the test cases Tᵢ are created. Various computational methods and algorithms, in particular algorithms of artificial intelligence, can be provided for establishing the test strategy.

After selecting a test case Tᵢ, the software application 420 creates a simulated scenario SZsᵢ for this test case Tᵢ that reflects the simulation of the behavior of the ADAS/ADS system 210 or a travel function of the ADAS/ADS system 210 for a defined driving task.

To assess the performance of an ADAS/ADS system 210, the simulated scenarios SZsᵢ created by the simulation are forwarded to the assessment module 500 for calculation of assessment indicators 570, in particular in the form of KPIs. For this purpose, the assessment module 500 comprises a software application 520 that evaluates the simulated scenarios SZsᵢ with regard to the performance and functionality of one or more functions or the overall performance of the considered ADAS/ADS system 210, in particular in the form of performance indicators (KPIs). For this purpose, the software application 520 uses calculation methods and/or algorithms of artificial intelligence, such as neural networks for the creation of the assessment indicators 570.

KPIs are used to describe the performance of the ADAS/ADS system 210 to be tested, and various KPIs are established for evaluation categories, such as comfort, safety, naturalness of travel and efficiency. Further KPIs can be implemented to verify the correct functionality of the ADAS/ADS system 210 being tested. One example of a KPI is the evaluation of a minimum distance from another vehicle or a mean acceleration in a deceleration scenario. The KPIs can be represented by numeric values or Boolean values. For example, a scale of 1 to 100 can be provided for the KPI metrics.

Real-world scenarios SZrᵢ identified by the scenario identification module 300 are forwarded to the assessment module 500 for determining assessment indicators 570 in the form of KPIs to assess the quality of the ADAS/ADS system 210 used.

To compare the defined KPIs of various real-world scenarios SZrᵢ or the KPIs of simulated scenarios SZsᵢ with real-world scenarios SZrᵢ , the scenario parameters Pᵢ and the scenario parameter values PVᵢ of the respective scenario SZᵢ are used as assessment metrics. For this purpose, the simulated scenarios SZsᵢ, the real-world scenarios SZrᵢ and the defined KPIs are forwarded to the evaluation module 700. The evaluation module 700 comprises a software application 720 that generates evaluation results 750 from the transmitted information in the form of KPI plots.

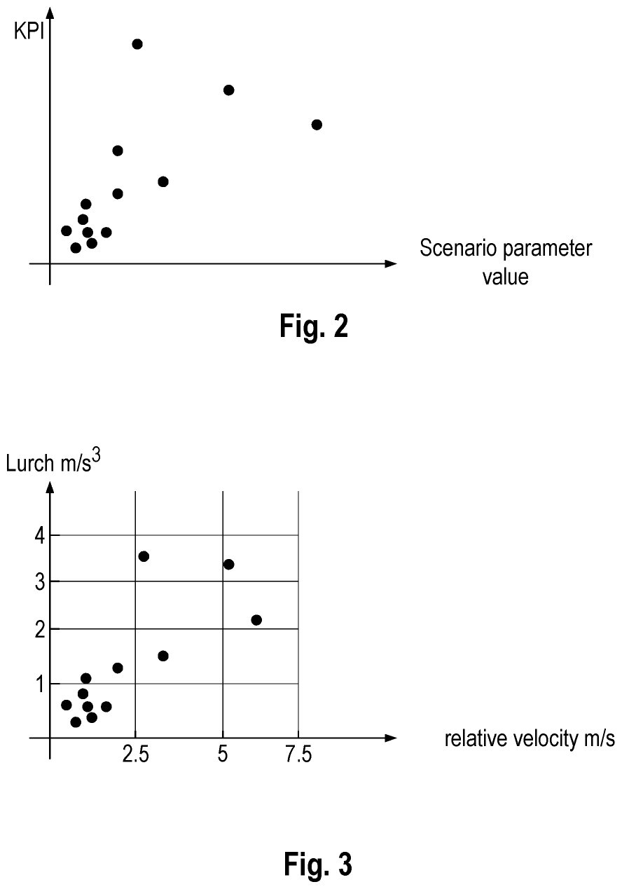

FIG. 2 shows an exemplary KPI plot in which the values of a KPI are shown as a function of the parameter values PVᵢ of a scenario parameter P₁. Each point in the plot represents a real-world scenario SZrᵢ or a simulated scenario SZsᵢ. For example, to enable comparability of the KPIs for a driving situation tested with the ADAS/ADS system 210, a first KPI plot with real-world scenarios SZrᵢ and a second KPI plot with simulated scenarios SZsᵢ are created.

For the example of the cut-in scenario already considered, a first parameter P₁ can be the relative speed vᵣₑₗ between the first-person vehicle 200 and a target vehicle, and the KPI can be the brake lurch, i.e., the temporal rate of change of acceleration of the vehicle 200 during the cut-in scenario. Such a KPI plot is shown in FIG. 3. Because the KPI plot shows the results from a plurality of simulations or from a plurality of measured scenarios, the calculated KPIs for a parameter value PVᵢ can vary. In addition, the KPI plot is broken into segments to visualize cluster formation in each segment. Depending on a value of the cluster formation, the segments will be labeled variously, for example with various colors to simplify the comparison of two KPI plots.

From the KPI plot shown in FIG. 3, it can be inferred that, at a low relative speed between the two vehicles, a low KPI value is obtained. The higher the relative speed between the two vehicles, the higher the KPI value. Deviations from this rule arise, this can be an indication to consider the real-world scenario SZrᵢ or simulated scenario SZsᵢ associated therewith more closely.

In particular, the KPI plots from variously configured ADAS/ADS systems 210 are compared to one another for a driving task to be able to objectively, precisely, and comprehensibly assess the performance of an ADAS/ADS system 210 in this way.

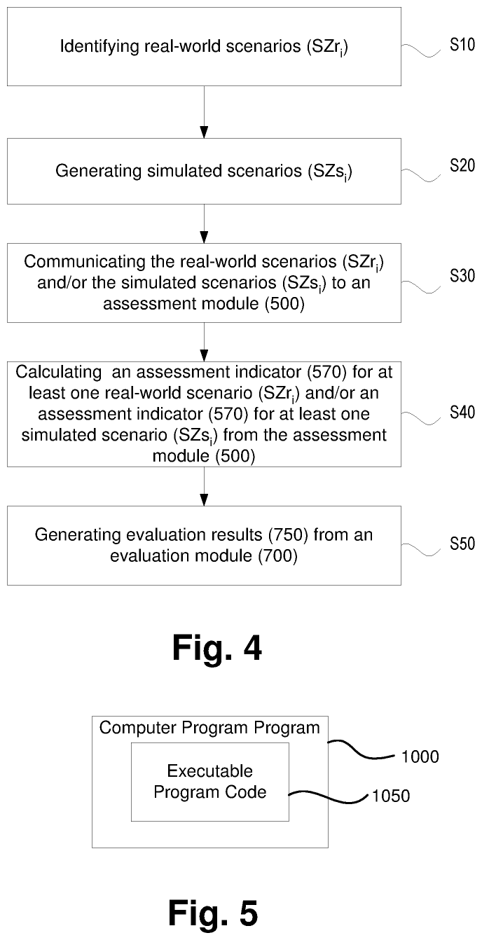

In FIG. 4, the method steps for objective assessment of the performance of an ADAS/ADS system 210 of a vehicle 200 for a defined driving task in at least one selected scenario SZᵢ are shown.

In step S10, real-world scenarios SZrᵢ are identified from real-time captured data from sensors 220 while traveling on a test path with the vehicle 200 or from stored data from a scenario identification module 300.

In step S20, simulated scenarios are generated SZsᵢ by a simulation module 400.

In step S30, the real-world scenarios SZrᵢ and/or the simulated scenarios SZsᵢ are communicated to an assessment module 500.

In step S40, the assessment module 500 calculates an assessment indicator 570 for at least one real-world scenario SZrᵢ and/or an assessment indicator 570 for at least one simulated scenario SZsᵢ. The assessment indicator 570 represents the performance of the ADAS/ADS system 210 for the defined driving task.

In step S50, evaluation results 750 are generated by an evaluation module 700. An evaluation result 750 for a real-world scenario SZrᵢ and/or a simulated scenario SZsᵢ includes a mapping between the respective determined assessment indicator 570 and the scenario parameter value PVcᵢ of a selected scenario parameter Pcᵢ of the respective real-world scenario SZsrᵢ and/or the respective simulated scenario SZsᵢ.

FIG. 5 schematically represents a computer program product 1000 comprising an executable program code 1050 that is configured so as to perform the method according to the first aspect of the present invention.

The invention enables test results from variously configured ADAS/ADS systems to be evaluated and compared to one another objectively by calculating assessment indicators for scenarios and/or simulated scenarios generated from measurements. For this purpose, a calculated assessment indicator for a real-world scenario and/or a simulated scenario is set in relation to a scenario parameter value of a selected scenario parameter, in particular in the form of KPI plots. This results in an objective metric that enables the assessment indicators of variously formed ADAS/ADS systems to be compared to one another. For example, KPI plots generated from at least two ADAS/ADS systems may be displayed side-by-side on a display device, e.g., the display device being coupled to system 210, cloud computing infrastructure 800, etc., for comparison and analysis. In another embodiment, the KPI plots generated from at least two ADAS/ADS systems may be overlaid upon each other on the display device for comparison and analysis, for example, to align like color-coded segments to facilitate analysis. In a further embodiment, a processor, e.g., a processor disposed in the evaluation module 700 or any other module, may perform the comparison of the KPI plots via an image analysis algorithm or function. In this embodiment, the processor may determine a deviation between the KPI plots that exceeds a predetermined, adjustable threshold and generates a recommendation to reduce the deviation. In this example, the recommendation may be human readable text that describes the deviation and how to reduce the deviation. In another example, the recommendation may be a calibration of the ADAS/ADS system, e.g., the recommendation includes newly generated calibration parameters. In a further example, the recommendation may be generated as an executable program code to modify the operation of at least one ADAS/ADS system to reduce the deviation, where a processor of the at least one ADAS/ADS system is automatically updated with the newly generated executable program code.

The present invention thus allows the performance of an ADAS/ADS system to be assessed objectively, precisely, and comprehensibly so that possible measures for improvement can be developed on this basis. Overall, the estimation of the safety and functionality of one or more driving functions of an ADAS/ADS system for a particular driving task can be improved significantly. In this way, resources can be conserved, since actual departures from test routes both with standard traffic situations as well as with specific corner cases can be reduced.

### REFERENCE NUMERALS

100 System
200 Vehicle
210 ADAS/ADS system
220 Sensors
240 Database
250 Input module
300 Scenario identification module
320 Software application
340 Scenario database
400 Simulation module
410 Testing scenario database
420 Software application
500 Assessment module
520 Software application
570 Assessment indicators
700 Evaluation module
720 Software application
750 Evaluation results
800 Cloud computing infrastructure
1000 Computer program product
1050 Program code

1. A method for objective assessment of the performance of an ADAS/ADS system (210) of a vehicle (200) for a defined driving task in at least one selected scenario (SZᵢ), in particular for testing and training at least one driving function of the advanced driver assistance system (ADAS) and/or the automated driving system (ADS), wherein a scenario (SZᵢ) represents a traffic event in a temporal sequence and is defined by a selection of scenario parameters (P₁, P₂, . . . , Pₙ) and associated scenario parameter values (P₁, P₂, . . . , Pₙ), comprising:
identifying (S10) real-world scenarios (SZrᵢ) from data captured in real-time by sensors (220) while traveling on a test path with the vehicle (200) and/or from stored data from a scenario identification module (300); and/or
generating (S20) simulated scenarios (SZsᵢ) from a simulation module (400);
communicating (S30) the real-world scenarios (SZrᵢ) and/or the simulated scenarios (SZsᵢ) to an assessment module (500);
calculating (S40) an assessment indicator (570) for at least one real-world scenario (SZrᵢ) and/or an assessment indicator (570) for at least one simulated scenario (SZsᵢ) from the assessment module (500), wherein the assessment indicator (570) represents the performance of the ADAS/ADS system (210) for the defined driving task;
generating (S50) evaluation results (750) from an evaluation module (700), wherein an evaluation result (750) for a real-world scenario (SZrᵢ) and/or a simulated scenario (SZsᵢ) includes a mapping between the respectively determined assessment indicator (570) and the scenario parameter value (PVcᵢ) of a selected scenario parameter (Pcᵢ) of the respective real-world scenario (SZrᵢ) and/or the respective simulated scenario (SZsᵢ); and
calibrating the ADAS/ADS system on the vehicle based on the evaluation results (750).

2. The method of claim 1, wherein the scenario parameter value (PVᵢ) of the selected scenario parameter (Pᵢ) of the respective real-world scenario (SZrᵢ) and/or the respective simulated scenario (SZsᵢ) is extracted by the evaluation module (500) from the dataset of the real-world scenario (SZrᵢ) and/or the simulated scenario (SZsᵢ).

3. The method of claim 1, wherein the assessment indicators (570) are configured as key performance indicators (KPIs).

4. The method of claim 3, wherein the evaluation results (750) are configured as KPI plots, values of a KPI in each of the KPI plots represent as a function of the parameter values (PVᵢ) of a scenario parameter (P₁) for a particular scenario (SZᵢ), and each plot point includes a real-world scenario (SZrᵢ) or a specific simulated scenario (SZsᵢ).

5. The method of claim 4, wherein the KPI plots for variously formed ADAS/ADS systems (210) and/or the KPI plots for various real-world scenarios (SZrᵢ) and/or for simulated scenarios (SZsᵢ) and real-world scenarios (SZrᵢ) for an ADAS/ADS system (210) are compared to one another.

6. The method of claim 4, wherein the KPI plots are histograms with segments for cluster analysis.

7. The method of claim 1, wherein: the scenario identification module (300) comprises a software application (320) that uses computational methods and/or algorithms of artificial intelligence; the simulation module (400) comprises a software application (420) that uses the computational methods and/or algorithms of artificial intelligence; the assessment module (500) comprises a software application (520) that uses the computational methods and/or algorithms of artificial intelligence; and the evaluation module (700) comprises a software application (720) that uses the computational methods and/or algorithms of artificial intelligence.

8. The method of claim 7, wherein the computational methods and/or algorithms of artificial intelligence are configured as mean values, minimum and maximum values, lookup tables, expected value models, linear regression methods, Gaussian processes, fast Fourier transforms, integral and differential calculations, Markov methods, probability methods, Monte Carlo methods, temporal difference learning, extended Kalman filters, radial basis functions, data fields, convergent neural networks, deep neural networks, recurrent neural networks, and/or folded neural networks.

8. The method of claim 1, wherein a scenario parameter (Pᵢ) comprises a physical variable, a chemical variable, a torque, a speed, a voltage, a current strength, a speed, an acceleration, a lurch, a braking value, a direction, an angle, a radius, a location, a number, a movable object such as a motor vehicle, a person or a cyclist, a stationary object such as a building or tree, a road configuration such as a highway, a road sign, a traffic light, a tunnel, a roundabout, a turn-off lane, a traffic volume, a topographical structure such as an incline, a time, a temperature, a precipitation value, a weather condition and/or a time of year.

9. A system (100) for testing and training at least one driving function of the advanced driver assistance system (ADAS) and/or the automated driving system (ADS), wherein: a scenario (SZᵢ) represents a traffic event in a temporal sequence and is defined by a selection of scenario parameters (P₁, P₂, . . . , Pₙ) and associated scenario parameter values (P₁, P₂, . . . , Pₙ), comprising sensors (220) connected to the vehicle (200), a scenario identification module (300), a simulation module (400), an assessment module (500), and an evaluation module (700); the sensors (220) are configured to capture data in real-time while traveling on a test path with the vehicle (200); the scenario identification module (300) is configured to generate real-world scenarios (SZrᵢ) from the data of the sensors (220) captured in real-time or from stored data; the simulation module (400) is configured to generate simulated scenarios (SZsᵢ); the assessment module (500) is configured to calculate an assessment indicator (570) for at least one real-world scenario (SZrᵢ) and/or an assessment indicator (570) for at least one simulated scenario (SZsᵢ), the assessment indicator (570) represents performance of the ADAS/ADS system (210) for the defined driving task; and the evaluation module (700) is configured to generate evaluation results (750), an evaluation result (750) for a real-world scenario (rSZsᵢ) and/or a simulated scenario (SZsᵢ) includes a mapping between the respectively determined assessment indicator (570) and the scenario parameter value (PVᵢ) of a selected scenario parameter (Pᵢ) of the respective real-world scenario (SZrᵢ) and/or the respective simulated scenario (SZsᵢ).

10. The system (100) of claim 9, wherein the assessment indicators (570) are key performance indicators (KPIs) and the evaluation results (750) are KPI plots.

11. The system (100) of claim 10, wherein the values of a KPI in the KPI plots are represented as a function of the parameter values (PVᵢ) of a scenario parameter (P₁) for a particular scenario (SZᵢ), and each plot point includes a real-world scenario (SZrᵢ) or a simulated scenario (SZsᵢ).

12. The system (100) of claim 10, wherein the KPI plots for variously formed ADAS/ADS systems (210) and/or the KPI plots for various real-world scenarios (SZrᵢ) and/or for simulated scenarios (SZsᵢ) and real-world scenarios (SZrᵢ) for an ADAS/ADS system (210) are compared to one another.

13. A computer program product (1000) comprising an executable program code (1050) configured to execute the method of claim 1.
